(19) United States
(12) Patent Application Publication
(10) Pub. No.: US 2016/0114896 A1
(43) Pub. Date: Apr. 28, 2016

(54) Alternative Fuel Source Vehicle

(71) Applicant: Thomas Heresco, Corvallis, OR (US)

(72) Inventor: Thomas Heresco, Corvallis, OR (US)

(21) Appl. No.: 14/526,129

(22) Filed: Oct. 28, 2014

(51) Int. Cl. B64D 27/24; B64C 27/78; B64C 27/00; B64C 27/10; B64C 27/82

(52) U.S. Cl. CPC B64D 27/24; B64C 27/10; B64C 27/82; B64C 27/008; B64C 27/78; B64C 2027/8227

(57) ABSTRACT

The production of energy from sources other than traditional hydrocarbons, such as fossil-fuels, is presented herein. Furthermore, an exemplary vehicle that utilizes such fuel sources is also presented herein. The exemplary vehicle is a helicopter with contra-rotating blades and winglets that provide stability and directional control. The helicopter possesses novel features, components, and abilities that form inventive elements not found within the prior art.

### CROSS-REFERENCES TO RELATED APPLICATIONS

This application claims priority to U.S. Provisional Patent Application Ser. No. 61/896,411 filed on Oct. 28th, 2013 entitled “Alternative Fuel Source Production and Vehicle”, the disclosure of which is hereby incorporated by reference.

### FIELD OF THE INVENTION

The present invention relates to the production and sourcing of alternate fuels, aviation modalities, and more specifically, to air vehicles such as helicopters which utilize alternate fuel sources.

### BACKGROUND OF THE INVENTION

Aviation vehicles featuring rotationally-directed blades are well known within the art. These blades can provide propulsion to certain crafts in a plurality of directions, subsequently forcing sufficient air over and under an airfoil. The angles or geometry of these blades will create a pressure differential between the top of the airfoil, and the bottom of the airfoil, imparting lift forces upon the craft.

Another modality of lift sees overhead, transversely-mounted rotating blades. These blades are often larger than push/pull type rotating blades, as the blades must support the weight of the craft being lifted. As the blades rotate, air is again forced under and over the blade surface, creating lifting forces which are then imparted unto the craft. Due to the rotational inertia created by these blades spinning at a high rate of speed, a tail rudder is generally implemented, and employs the same, albeit smaller, forces in a horizontal plane, counteracting rotation of the craft.

Unfortunately, tail rudders can be susceptible to damage. This can be problematic as a damaged tail rudder would see the craft and occupants being acted upon by the rotational forces of the blades. This often ends poorly for the craft and user, as the craft cannot maintain lift, nor resist craft rotation. One way to overcome this downfall is to employ counter-rotating blades.

Counter-rotating coaxial rotors are known within the art. This modality sees blades which rotate independent and opposing one another. This counteracts any rotational forces, and allows the craft to adjust directionality by slowing one rotorset down in relation to one another, rotating the craft in the preferred direction. Due to the directionality feature employed by this method, a tail-boom mounted tail rudder is unnecessary.

Unfortunately, one of the main disadvantages of counter-rotating coaxial rotors is represented by the considerable complexity of the rotor members for controlling the blades, with particular attention to the power transfer between the rotors. If rotor speeds vary, the craft will rotate in a direction opposite the blade.

Another modality to regulate rotational forces is to employ angular bevels to the craft itself. Once the downdrafting air contacts this beveled assembly, anti-directional force is applied to the craft, and rotational torque is canceled out.

Gas turbine engines are known within the art. Traditionally, rotating-blade craft such as helicopters employ a gas-turbine engine which provides the necessary energy to drive the mass in the blade assembly. These engines typically include a fan delivering air into a compressor. The air is compressed within the compressor, and delivered into a combustion area where it is mixed with fuel and ignited. Products of this combustion pass over turbine rotors, which in turn, provide rotational energy to the compressor and fan.

Fan rotors are becoming increasingly large in size. This size increase presents challenges in regards to operation and packaging. It has been proposed to drive a plurality of fan rotors from a single gas-turbine engine. The enlargement of fan diameter has increased with the recent development of a gear reduction driving the fan from the turbine rotor. Unfortunately, these engines produce less-than-ideal greenhouse gasses.

One way to offset noxious greenhouse gases stemming from the burning of fossil fuels, is to employ a hybrid-type engine. These engines often see smaller gas engines powering electrical motors, which then transfer that energy into motion. Unfortunately, these engines is the units still require fossil fuels for combustion.

Non-fossil-fuel engines are known within the art. These engines exist in the form of an apparatus for the production of gaseous fuel vapor. The system includes a hydrogen generator with an electrolyte tank for generating hydrogen and oxygen gas from an electrolytic solution in the electrolyte tank, and a means for delivering hydrocarbon fuel and the generated hydrogen from the electrolyte tank into a venturi mixing tube which is directly connected to the carburetor of the engine. The generated oxygen gas is then vented from the electrolyte tank.

Nitrous oxide is an air pollutant which is proven to be at least 300 times more effective than carbon dioxide as a “greenhouse gas”. This gas is considered hazardous for people exposed to it during various activities. Occupational health limits have been set to 25 ppm. Cost-effective and convenient apparatuses, systems and methods for reducing discharge of the gas to the atmosphere are likely to be imperative in the future.

One such method of capturing nitrous oxide is to collect the gas and diffuse it through liquid water. The product would be a dissolvable salt which can easily be discarded or reused.

It could be said there lies a need for an aviation-based vehicle which employs an alternatively sourced fuel.

### BRIEF SUMMARY OF THE INVENTION

An object of the present invention relates to the utilization by a vehicle of energy from sources other than traditional hydrocarbons such as fossil-fuels. Another object of the present invention relates to a helicopter that utilizes such fuel sources.

One embodiment of the present invention is a helicopter with contra-rotating blades and winglets that provide stability and directional control. This embodiment possesses features, components, and abilities that are not found within the prior art.

Other novel features which are characteristics of the invention, as to organization and method of operation, together with further and advantages thereof will be better understood from the following description considered in connection with the accompanying figures, in which preferred embodiments of the invention are illustrated by way of example. It is to be expressly understood, however, that the figures are for illustration and description only and are not intended as a definition of the limits of the invention. The various features of novelty which characterize the invention are pointed out with particularity in the following description. The invention resides not in any one of these features taken alone, but rather in the particular combination of all of its structures for the functions specified.

A further understanding of the present invention can be obtained by reference to a preferred embodiment set forth in the accompanying description. Although the illustrated embodiments are merely exemplary of methods for carrying out the present invention, both the organization and method of operation of the invention, in general, together with further objectives and advantages thereof, may be more easily understood by reference to the illustrations and the following description. The figures are not intended to limit the scope of this invention, but merely to clarify and exemplify the invention.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter. Those skilled in the art will appreciate that the conception upon which this disclosure is based may be readily utilized as a basis for the designing of other structures, methods and systems for carrying out the purposes of the present invention. It is important, therefore, that any embodiments of the present invention be regarded as including such equivalent constructions insofar as they do not depart from the spirit and scope of the present invention.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

Referring now to the present invention, there is introduced an alternative fuel sourced helicopter. For the purpose of clarity, all like elements mentioned in this description, or illustrated in the accompanying Figures, will have the same designations. The terms “present invention”, “helicopter”, and “invention” may be used interchangeably. In addition to the functions, features, components, and abilities of the invention already discussed in this specification, the invention may also have, but not be limited to, the following features contained within the description below.

The present invention solves the shortcomings of the prior art by providing a helicopter with an energy production system that produces energy in an alternative manner compared to traditional fossil fuel engines. The preferred embodiments described below set forth the present invention in greater detail.

The present invention provides counter-rotating coaxial rotor blades that provide lift to the helicopter, hereinafter referred to as contra-rotating blades. The contra-rotating blades rotate independent and opposite of one-another. This counteracts any rotational forces, and allows the craft to adjust directionality by slowing one rotorset down in relation to one another thereby rotating the craft in the preferred direction. Due to the directionality feature employed by this method, a tail-boom mounted tail rudder is unnecessary.

An embodiment of the present invention provides a helicopter with an alternative fuel-source engine. Scalar torque is provided by the engine. The helicopter possesses a co-axial contra-rotor gear, and two winglets that can act as rudders. The winglets are triangular and swept-back so that the helicopter can use downwash to maneuver. Tilting them both straight down reduces downwash pressure on the rear of the craft relative to the front, causing the helicopter to pitch forward. Tilting the winglets so that they are perpendicular to the downwash increases downwash pressure on the rear of the craft and causes the nose to pitch up.

The triangular shape of the winglets provides the helicopter with similar maneuvering capabilities compared to traditional helicopters. The helicopter can move about multiple axes at the same time, in any combination of directions. Reversing the tilt of the winglets from inward to outward creates a downwash tripod, and lessens wind angles. This creates a forward slide or hover/cruise mode. The widest points of the winglets are at the center of the vehicles mass for balance. The winglets are provided with slight trimmable angles to compensate for sideborne loads.

Embodiments of the present invention use contra-rotating blades to provide unique levels of stability and speed. The blades are curved to cause self-stabilizing progression. The blades are of a smaller diameter than traditional, non-contra rotating blade helicopters, thereby allowing higher rpms and greater stability to be achieved.

The use of contra-rotating blades reduces progressive torque imbalance problems, caused by hitting a ski on takeoff, or by losing the tail. Because the helicopter makes use of contra-rotating blades, evening out the attitude, and lowering engine torque would help stabilize the craft should major systems failures occur.

In traditional helicopters, gyroscopic rotor motion mean that a craft's Center of Mass (CoM) and Center of Lift (CoL) must be perfectly aligned. The present invention provides a contra-rotating rotor shaft with attached spinning flywheels in the fuselage that provide gyroscopically self-stabilization for the CoL, and allow the CoM to favor forward momentum. The contra-rotating rotor shaft comprises two rotor shafts, one inside of the other that rotate in opposite directions. One rotor shaft is attached to the first set of contra-rotating rotor blades and causes the rotor blades to rotate in one direction, and the second rotor shaft is attached to the second set of contra-rotating blades and causes the second set to rotate in an opposite direction from the first. One flywheel is attached to each shaft that comprises the contra-rotating rotor shaft. Increasing the weight or diameter of the flywheels increase the effect and self-stabilization properties of the helicopter. Since each spinning flywheel stabilizes the craft relative to its rotational direction, contra-rotating spinning flywheels stabilize the craft in multiple directions simultaneously.

One embodiment of the present invention utilizes an oxyhydrogen engine to provide motive power for the helicopter. Oxyhydrogen engines are well-known within the prior art and are commonly used in automotive applications. The present invention will use an oxyhydrogen engine, an associated electrolytic cell, and a condenser. The oxyhydrogen engine runs on water. For 15.89 MJ of electricity, one can electrolyze 1 L of water, in which 31.4 MJ can be combusted in a gaseous combustion to drive pistons similar to a fossil-fuel combustion engine. Lightweight batteries or solar panels, some with electric heat transfer condensers, can be used to provide the electricity for the oxyhydrogen engine.

The O2 and H2 derived from electrolysis will be combusted in gas form in the oxyhydrogen engine. A gallon of gasoline has 1.3×10̂8 J of energy, Hydrogen has 286 kJ/mol. The oxyhydrogen engine will combust between 4%-97% H2. The oxyhydrogen engine is capable of injecting high volumes of gas because of the energy difference between liquid gasoline and gaseous H2. As a comparison, one liter of gasoline in liquid form contains 34.3 megajoules of energy while one liter of gaseous H2 provides 12.7 kilojoules of energy.

To collect water vapor, the condensers are applied to the exhaust system. Electricity from solar panels can be used in an electric transmission and motor and to drive electrolysis (−e+2H2O→O2+2H2) of the water, converting the hydrogen in H2O into a gas form for the engine.

In addition, any nitrous oxide escaping the exhaust system is filtered out and combined with water vapor. After being combined with water vapor, it will yield combinations of ammonium nitrate, nitric acid, and sodium nitrate.

Another embodiment of the present invention utilizes a superconductive electric engine. Vortex fields cause the helicopter's rotor shaft to turn, which in turn causes the helicopter blades to spin thereby generating lift. The vortex fields are created in the electric engine by thick, superconductive, wiring that is wrapped in a cone that generate a spinning, upward-vectored electromagnetic vortex. The base of the rotor shaft responds to the vortex fields by rotating in the same direction as the electromagnetic vortex.

A sodium bicarbonate (NaCHO3) fire suppression system is utilized by the helicopter to avoid electric shorts and other hazards common with water-based systems. Sodium bicarbonate is made by reaction of CO2 with sodium hydroxide; CO2+2CO2+2NaOH→Na2CO3 [sodium carbonate]+H2O. Adding CO2 causes sodium bicarbonate to precipitate from the solution, Na2CO3+CO2+H2O→2NaHCO3.

Sodium hydroxide (lye) is commonly used in the prior art for saponification. Combined with the right triglyceride it is safe to handle and can be used as a defogger on the windscreen of the helicopter. In condensation formed, it forms soap salts and glycerol, remains transparent, and easy to clean.

Activated alumina is used in embodiments of the present invention for desiccant and adsorbent purposes and to clean activated condensers and filters within the helicopter. Activated alumina uses aluminum hydroxide to precipitate with impurities and form gels, which crystallize with time Aluminum hydroxide gels can be dehydrated to form aluminum hydroxide powders, which are readily soluble in acids. The powders are used to clean activated alumina condensers and filters within the helicopter. Activated alumina is commonly made by removing hydroxyl groups —OH from Al(OH)3, resulting in a porous aluminum. It is ideal for the condenser surfaces and filters, and can be auto cleaned with sodium hydroxide, to remove fluoride as a filter, and can react carbon into carbon salts. By way of example, when sodium hydroxide mixes with CO2, then 2 NaOH+CO2→Na2CO3 [sodium carbonate]+H2O.

Sodium hydroxide is used in the oxyhydrogen engine condenser. Sodium hydroxide is deliquescent, as is sodium bicarbonate and sodium chloride which may be used in some embodiments of the present invention, that absorbs both water and carbon dioxide and emit water. The absorbed carbon remain in a salt crystal form.

Another condenser reaction that can be used with embodiments of the present invention is the Solvay process; 2NaCl [sodium chloride]+CO2+NH3 [ammonia]+H2O→NaHCO3 [sodium bicarbonate]+NH4Cl [ammonium chloride]. The fundamental salt collection method is the Solvay process for the condenser using propwash pressure to extract vapor; 2NaCl [sodium chloride]+CO2+NH3 [ammonia]+H20--->NaHCO3 [sodium bicarbonate]+NH4Cl [ammonium chloride].

After salts are removed from electrolytic cell of the oxyhydrogen engine, it the alkalinity of the electrolytic cell is altered, allowing more of these chemicals into the engine. Ammonia will split into hydrogen and the nitrogen will bond with oxygen for nitric oxide. HCl may divide into hydrogen and Cl2, or combine to form table salt which, if left as ammonium chloride or HCl, will clean the electrolytic cell. The electrolytic cell should break HCl down; OH—+HCl→H2O+Cl—, allowing it to make Cl2 or NaCl, so a salt filter retains ammonium chloride without decomposing it.

The temperature and pressure thresholds of the electrolysis cell and condenser are maintained at so that the helicopter functions at flight ceiling, at the equator, and at the earth's frozen poles.

Lithium and bromine are used in embodiments that utilize solar panels to generate electricity for the system. Certain bromides are used in photochemistry due to their ability to capture low-energy electrons, then divert those electrons directly into a superconductive metal, using a noble gas, then into rechargeable batteries, increasing the efficiency of solar cells. Bromine is electronegative and electrophilic, also, the carbon-halogen bond strengths, or dissociation energy for iodine is only 57.6 kcal/mol, so halides may be used in embodiments of the present invention.

For solar panel embodiments, a superconductive anode in a noble gas will be covered by a halide panel. Halides, like iodine, get their dark color because they absorb light. A solar panel with a halide outer layer then a noble gas layer, useful due to its extremely high ionization energies, can will transfer electrons from itself into a superconductive filament.

In a noble gas, a superconductive filament provides charge for the battery, after the photons have been slowed by the halide, and move into the noble gas as electrons. The noble gas does accept electrons and they are instead absorbed in a superconductive filament in the noble gas. Essentially, halide compounds are placed on a noble gas bulb with a room temperature superconductive filament inside and photons are received on the EM spectrum. The photons are slowed in halide, do not stay with the noble gas and go to the superconductive anode instead. The electromagnetic waveform is changed by the halide to harmonize with the orbitals of the noble gases at a given temperature. For efficiency the element(s) chosen to bond with the halide, the chosen filament, and the chosen gas have the property that the wavelength of light passing through the halide divided by the atomic orbital radius of the noble gas divide evenly with almost no remainder. Thus, they will resonate, and electromagnetic energy will flow from halide layer to noble gas layer, the noble gas layer then transferring them to the superconductive filament, and then into the battery.

The above detailed description sets forth rather broadly the more important features of the present invention in order that its contributions to the art may be better appreciated.

As such, those skilled in the art will appreciate that the conception, upon which disclosure is based, may readily be utilized as a basis for designing other structures, methods, and systems for carrying out the several purposes of the present invention. It is important, therefore, that this description be regarded as including such equivalent constructions insofar as they do not depart from the spirit and scope of the present invention.

Although certain example methods, apparatus and articles of manufacture have been described herein, the scope of coverage of this provisional patent application is not limited thereto. On the contrary, this provisional patent application covers all methods, apparatus and articles of manufacture fairly falling within the scope of the invention either literally or under the doctrine of equivalents.

To the extent the above specification describes example components and functions with reference to particular compliance requirements, standards and/or protocols, it is understood that the teachings of this disclosure are not limited to such compliance requirements, standards and/or protocols. Such compliance requirements, standards and/or protocols are periodically superseded or revised by newer versions. Accordingly, replacement compliance requirements, standards and/or protocols having the same general functions are equivalents which are intended to be included within the scope of this description.

Directional terms such as “front”, “forward”, “back”, “rear”, “in”, “out”, “downward”, “upper”, “lower”, “top”, “bottom”, “outer”, “interior” and the like may have been used in the description. These terms are applicable to the embodiments shown and described herein. These terms are merely used for the purpose of description and do not necessarily apply to the position in which components or items within the present invention may be used.

Therefore, the foregoing is considered as illustrative only of the principles of the present invention. Further, since numerous modifications and changes will readily occur to those skilled in the art, it is not desired to limit the present invention to the exact construction and operation described, and accordingly, all suitable modifications and equivalents may be resorted to, falling within the scope present invention. While the above description describes various embodiments, it will be clear that the present invention may be otherwise easily adapted to fit any configuration as desired or required.

As various changes could be made in the above constructions without departing from the scope of the invention, it is intended that all matter contained in the above description shall be interpreted as illustrative and not in a limiting sense

I claim:

1. A helicopter comprising:
a first counter-rotating set of rotor blades that rotate in a first direction; a second counter-rotating set of rotor blades that rotate in a direction opposite from the first set of rotor blades, the first and second sets of rotor blades providing lift to the helicopter and allowing the helicopter to adjust directionality by slowing one set of rotor blades in relation to the other set of rotor blades, each set of rotor blades rotating independently of each-other; a contra-rotating rotor shaft comprised of a first rotor shaft that is attached to the first counter-rotating set of rotor blades and a second contra-rotating rotor shaft that is attached to the second set of counter-rotating set of rotor blades, each rotor shaft rotating in an opposite direction and independently from each other; a first flywheel attached to the first rotor shaft, a second flywheel attached to the second rotor shaft, each flywheel rotating in an opposite direction and independently from each other; an alternative fuel-source engine that provides scalar torque to the first and second set of rotor blades; and a set of winglets that allow the helicopter to maneuver when downwash from the first and second set of counter-rotating blades passes over the winglets, wherein tilting the winglets downward reduces downwash pressure on the rear of the helicopter relative to the front and causes the helicopter to pitch forward, and where tilting the winglets so that they are perpendicular to the downwash pressure on the rear of the craft and causes the nose of the helicopter to pitch up.

2. The helicopter of claim 1, wherein the flywheels self-stabilize the helicopter's center of lift.

3. The helicopter of claim 1, wherein the winglets are triangular and provide maneuverability to the helicopter when exposed to rotor blade downwash.

4. The helicopter of claim 1, wherein the alternative fuel-source engine is an oxyhydrogen engine with an associated electrolytic cell and condenser.

5. The helicopter of claim 4, wherein the oxyhydrogen engine electrolyzes water to produce hydrogen and oxygen.

6. The helicopter of claim 5, wherein the hydrogen produced from the electrolysis process is combusted in gas form in the oxyhydrogen engine to provide motive power for the helicopter.

7. The helicopter of claim 4, wherein the condenser collects water vapor for the electrolysis process.

8. A coaxial helicopter with counter-rotating rotor blades comprising:
an oxyhydrogen engine, an associated electrolytic cell, and a condenser; the oxyhydrogen engine combusting gases derived from an electrolysis process to provide torque to a first and second rotor shaft; the electricity used in the electrolysis process being generated from solar panels; the electrolysis process generating hydrogen and oxygen gas from water; the first rotor shaft being located within the second rotor shaft; the first rotor shaft rotating in an opposite direction and independently from the second rotor shaft; the first rotor shaft being connected to a first set of coaxial rotor blades, the second rotor shaft being connected to a second set of coaxial rotor blades; the first and second set of coaxial rotor blades rotating in an opposite direction and independently from each other; two triangular winglets that tilt in order to cause the helicopter to change pitch; and a first flywheel attached to the first rotor shaft, a second flywheel attached to the second rotor shaft, each flywheel rotating in an opposite direction and independently from each other.

9. The coaxial helicopter of claim 8, further comprising a sodium bicarbonate fire suppression system.

10. The coaxial helicopter of claim 8, wherein the solar panels contain a superconductive anode in a noble gas.

11. The coaxial helicopter of claim 10, wherein the noble gas is covered by a halide outer layer.

12. The coaxial helicopter of claim 8, wherein the water used in the electrolysis process is collected by the condenser.

13. The coaxial helicopter of claim 12, wherein the condenser is applied to the exhaust system.

14. A coaxial helicopter with counter-rotating rotor blades comprising:
a superconductive electric engine; the superconductive electric engine generating vortex fields that cause a first and a second rotor shaft to rotate; the vortex fields being generated in the superconductive electric engine by thick, superconductive wiring that is wrapped in a cone that generate an upward-vectored electromagnetic vortex; the first rotor shaft being located within the second rotor shaft; the first rotor shaft rotating in an opposite direction and independently from the second rotor shaft; the first rotor shaft being connected to a first set of coaxial rotor blades, the second rotor shaft being connected to a second set of coaxial rotor blades; the first and second set of coaxial rotor blades rotating in an opposite direction and independently from each other; and two triangular winglets that tilt in order to cause the helicopter to change pitch; and a first flywheel attached to the first rotor shaft, a second flywheel attached to the second rotor shaft, each flywheel rotating in an opposite direction and independently from each other.

15. The coaxial helicopter of claim 14, wherein the first flywheel and the second flywheel stabilize the helicopter relative to the rotational direction of each flywheel.

16. The coaxial helicopter of claim 14, wherein a hover mode for the helicopter is created by reversing the tilt of the winglets.

17. The coaxial helicopter of claim 14, wherein the winglets are provided with slight trimmable angles to compensate for sideborne loads.

18. The coaxial helicopter of claim 14, further comprising solar panels that are used to generate electricity for the helicopter.

19. The coaxial helicopter of claim 18, further comprising rechargeable batteries that store additional energy generated from the solar panels.

20. The coaxial helicopter of claim 18, wherein a superconductive anode is located within a noble gas, the superconductive anode absorbing photons that pass through the noble gas.
